(19) United States
(12) Patent Application Publication
(10) Pub. No.: US 2002/0013760 A1
(43) Pub. Date: Jan. 31, 2002

(54) System and method for implementing electronic markets

(76) Inventors: Arti Arora, Los Altos, CA (US); Edward Lazear, Portola Valley, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/823,956

(22) Filed: Mar. 30, 2001

Related U.S. Application Data
(60) Provisional application No. 60/193,966, filed on Mar. 31, 2000.

(51) Int. Cl. G06F 17/60

(52) U.S. Cl. 705/37

(57) ABSTRACT

An efficient system for implementing an electronic market. The system includes a first mechanism for defining a set of attributes and associated descriptor variables involved in market transactions. Importance values are assigned to the descriptor variables by the first mechanism. A second mechanism computes match scores for the market transactions based on the importance values. A third mechanism employs the match scores to clear the electronic market. In the specific embodiment, the first mechanism includes an administrator interface, which allows an administrator to define the descriptor variables. A configurator communicates with the administrator interface and allows the administrator to assign a first set importance values to corresponding descriptor variables. The first set importance values includes default importance values or importance values assigned to the descriptor variables by a seller seeking to transact with a buyer via the electronic market. The administrator interface allows an administrator to configure a user interface of the market to allow market participants to assign a second set of importance values to different descriptor variables. The second set of importance values includes buyer and seller importance values. The descriptor variables and associated descriptor importance values may be continuous or discrete. A matching engine computes the match scores for market transactions based on a predetermined evaluation method specified via the administrator interface and based on a unique match score computation method.

### CLAIM OF PRIORITY

This application claims priority from U.S. Provisional Patent Application No. 60/193,955, filed Mar. 31, 2000, entitled “Electronic Commerce System Including Weighted Characteristic Matching, Dynamic And Automated Creation Of Markets, Analysis Tools And Administrator Interface” which is hereby incorporated by reference as if set forth in full in this document.

### CROSS-REFERENCES TO RELATED APPLICATIONS

This application is related to co-pending Patent Application No. [TBA], filed Mar. 30, 2001, entitled “Electronic Matching Engine For Matching Desired Characteristics With Item Attributes” (Attorney Docket 20512-1-1) and Patent Application No. [TBA], filed Mar. 30, 2001 entitled “Efficient Interface For Configuring An Electronic Market.” (Attorney Docket 20512-1-3).

### BACKGROUND OF THE INVENTION

1. Field of Invention

This invention relates in general to electronic transactions using digital processing systems, and more specifically to a system for creating and operating electronic marketplaces.

2. Description of the Related Art

Electronic commerce systems are becoming popular as a way for people to purchase or trade goods and services. Such systems often take the form of “stores” where a buyer can purchase a good, or “auctions” where a bidder can attempt to purchase an item by progressive bidding. The Internet provides an effective network to allow users, or buyers, to participate in electronic markets by using electronic commerce systems. Examples of such systems are at www.amazon.com or www.ebay.com.

Although such sites are effective in allowing a user to bid on, or directly purchase, items they are not without shortcomings. Because of the sheer number of items available, it is often difficult for a user to identify a desired item. Rudimentary search engines are typically provided by such sites. However, such search engines are restrictive in the types of queries that can be made and the results that are returned. Also, each system is set up to be a specific type of market. It is difficult, for example, to turn a direct purchase system into an auction system. The type of market must be decided upon from the beginning of the design of the system. Many months are usually needed to program, test and deploy the system. Once deployed, such systems are difficult to adapt to changing market needs. Also, the variety of markets that are provided by today's systems is very limited. These limitations are due, in part, to the searching, or matching, engines that perform the task of matching an item for sale with a set of characteristics desired by a buyer.

There are already a large number of electronic markets that have been conceived, but cannot be implemented because current engines are not able to deal with necessary intricacies. Many such markets involve services, where description of the item to be traded needs to be so detailed that the categories may lack any buyers or sellers who satisfy the criteria.

For example, services (as opposed to goods) are difficult to trade electronically because individuals who provide the services are heterogeneous. Unlike office supplies, workers are idiosyncratic, possessing different skills, having different experience, and wanting different characteristics in jobs that they are willing to take. Other engines deal with these idiosyncrasies in a rigid manner that lumps different people into the same category.

Current engines do not handle substitution between goods. For example, consider the market for a used car. A buyer is asked to specify the desired characteristics of a car. These include make, model, year, and possibly color. As the category narrows, fewer cars are presented to the potential buyer. At the end of the process, all cars within the desired category are listed as if they are perfect substitutes for one another. Those outside the category are not listed at all. But a buyer might prefer 1998 Honda Accord to a 1997 Toyota Camry at the same price. Current matching methods ignore these possibilities.

Current engines also do not provide mechanisms to value certain characteristics over others. Usually a buyer must provide the characteristics for use in a match. Provided characteristics must be present or there is no match. Characteristics that may not be very important to the buyer are treated the same as characteristics that the buyer deems essential.

Often a market administrator is in a position to set up a market type but is unsure, or ignorant, of the market type that would be most efficient. Traditional systems do not provide insight into the effects of using a particular market type for a particular commerce application.

### SUMMARY OF THE INVENTION

The present invention allows an administrator to create, run, model and adapt an electronic commerce system so that the system operates more efficiently. Many possible types of electronic markets can be created and managed. The system assists administrators in selecting the appropriate market and in improving the performance of an operating market.

In the illustrative embodiment, the inventive system is adapted for use with the Internet. The system includes a first mechanism for defining a set of attributes and associated descriptor variables involved in market transactions and assigning importance values to the descriptor variables. A second mechanism computes match scores for the market transactions based on the importance values. A third mechanism clears the electronic market in accordance with the match scores.

In a more specific embodiment, the first mechanism includes an administrator interface for allowing an administrator to define the descriptor variables. A configurator communicates with the administrator interface allowing the administrator to assign a first set of one or more importance values to one or more of the descriptor variables, respectively. The first set of one or more importance values includes default importance values or importance values assigned to the descriptor variables by a seller seeking to transact with a buyer via the electronic market.

The administrator interface includes a mechanism for configuring a user interface of the market to allow a participant in a market transaction to assign a second set of one or more of the importance values to the descriptor variables. The second set of one or more importance values includes buyer importance values assigned to the descriptor variables by a buyer seeking to transact with a seller via the electronic market. The descriptor variables and associated descriptor importance values may be continuous or discrete.

The second mechanism includes a matching engine for computing the match scores for market transactions based on a predetermined evaluation method specified via the administrator interface and based on a match score computation method. The predetermined evaluation method includes a mechanism for mapping descriptor values into corresponding preference numbers (Dᵢⱼᵣ) within a predetermined number range, such as between 0 and 1. The predetermined evaluation method includes a more is better method, an equal to method, a less is better method, and a distance method, among others. The (Dᵢⱼᵣ) variables can be computed from underlying raw data that can take the form of numerical or alphbetical descriptors. One innovation is allowing any type of data to be transformed into real numbers (often between zero and one). For example, a consumer preferring that something be made of nylon might receive a score of 0.6 (rather than one or zero) for something made of rayon or other related synthetic material. Software running on the matching engine uses the match score computation method to compute a total match score (Zᵢⱼ) based on the importance values according to the following equation:

$${Z}_{ij} = \sqrt{{Z}_{ij}^{i} {Z}_{ij}^{j}} ,$$

where Zᵢⱼⁱ is a match score based on importance values assigned by a first participant in the electronic market and any corresponding preference numbers Dᵢⱼᵣ, and Zᵢⱼ^{j} is a match score based on importance values associated with a second participant in the market and any corresponding preference numbers. (Dᵢⱼᵣ The functional form that relates the total score need not be a square root, but can be any function of the two underlying components Zᵢⱼ and Zᵢⱼ.) In the specific embodiment, the first participant is a seller and the second participant is a buyer. The third mechanism includes one-to-many market-clearing software and/or one-to-one market-clearing software. The one-to-one market-clearing software includes a mechanism for searching all total match scores Zᵢⱼ for market participants i and j (seller i and buyer j); selecting the maximum value of Zᵢⱼ; matching participant i to participants to yield cleared participants in response thereto; removing Zᵢⱼ corresponding to the cleared participants from the set of all Zᵢⱼ to yield a reduced Zᵢⱼ; and repeating the above steps for the reduced Zᵢⱼ. The one-to-one market-clearing software further includes a mechanism for clearing markets that maximizes the sum of all matches Zᵢⱼ and clears sections of a matrix of values corresponding to Zᵢⱼ.

The third mechanism includes an endogenous market definer that automatically defines the descriptor variables based on pre-existing market data. The third mechanism further includes a semi-endogenous market definer that selects a starting seller to participate in market transactions. The starting seller is chosen to match best with all buyers participating in the electronic market.

An electronic market implemented via the system of the present invention may be an internal allocation market, a business-to-business concierge, a modified competitive market, an electronic pawn shop, an electronic wholesaler, a trading post, an auction or qualified auction, a web credit market, and so on.

The novel design of the present invention is facilitated by the first means, which enables attributes of transaction entities, such as products or services, to be ranked in order of importance. Scores for transactions may be computed by ranking the importance of particular attributes. Consequently, buyer and seller desires are accurately modeled and used to optimally match transactions.

By employing continuous and/or discrete descriptor variables rather than discrete descriptor variables only, the present invention allows users to specify relative preferences between attributes. For example, a user may indicate that car safety features are more important than color by assigning a lower importance value to the car safety features attribute(s) than for the color attribute. Conventionally, a user could only specify whether they wanted a car with the safety attributes and/or the indicated color attribute or not.

Additionally, preference variables can be specified in a continuous fashion. For example, a basketball team might specify that it prefers a guard who is 6′4″ tall would not be ruled out automatically, but would received a lower rating than a player who was 6′3″ tall.

Unlike with conventional categorical markets, the probability of successfully recommending a product based on customer preferences does not decrease as possible specified categories increase. Consequently, the present invention enables implementation of certain market types that would otherwise be impossible to electronically implement via conventional categorical matching engines.

The present invention provides multi-attribute search and transaction matching capabilities with a controlled number of matches and employs a matching algorithm that can process fuzzy or vague descriptions of desired products. The matching algorithm can recommend products when a perfect match is not found and may accommodate different buyer and seller attribute preferences. Markets implemented via the present invention may recommend high-margin products when a customer is indifferent between two or more products. The matching algorithm is quick and efficient, reducing average search time to under a minute. Markets incorporating the present invention can handle any number of attributes while always returning a match or recommendation.

### BRIEF DESCRIPTION OF THE DRAWINGS

FIG. 1 is a diagram of a customizable matching system for implementing an electronic market constructed in accordance with the teachings of the present invention.

FIG. 2 is flow diagram of a method used by the customizable matching system of FIG. 1 to implement an electronic market.

### DESCRIPTION OF THE INVENTION

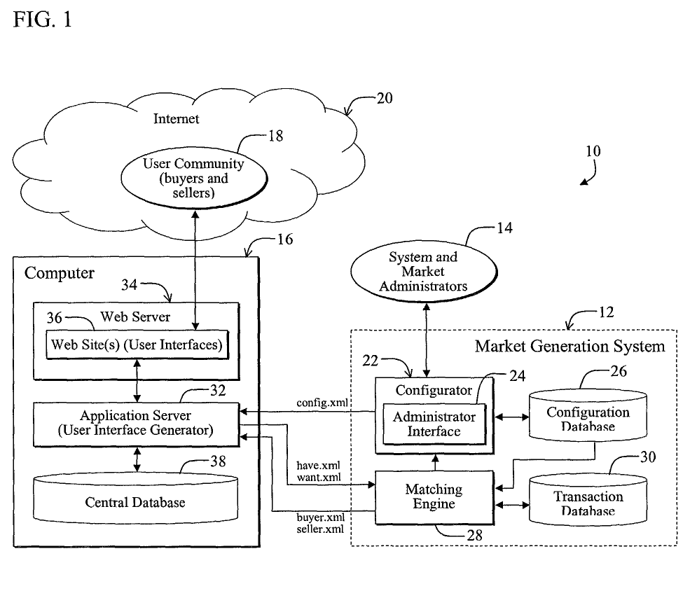

FIG. 1 is a diagram of a customizable matching system 10 constructed in accordance with the teachings of the present invention. For clarity, various components of the matching system 10, such as operating systems, modems, and power supplies are not shown in FIG. 1, however these components are well known and readily implemented by those skilled in the art.

The matching system 10 generates e-commerce markets and internal allocation markets by efficiently matching buyers and sellers, matching buyers to products, and/or matching internal tasks to employees, and so on, in accordance with the type(s) of market implemented by the matching system 10. For the purposes of the present discussion, the term market is defined as any system for matching or qualifying two or more entities in a transaction. This includes internal allocation systems. A market is typically associated with a physical or virtual location where entities, such as buyers and sellers, come together to sell or exchange goods and/or services. Furthermore, in the present discussion, the terms market and market configuration are used interchangeably. The market configuration represents a computer file (or other memory mechanism) with instructions and data for implementing an electronic market.

The matching system 10 includes a market generation system 12 in communication with system and market administrators 14 and a client computer 16. The client computer 16 communicates with a user community 18, which may include buyers and sellers, via the Internet 20.

The market generation system 12 includes a market configurator 22 having an administrator interface 24, a configuration database 26, a matching engine 28, and a transaction database 30. The administrator interface 24 enables market administrators 14 to quickly configure the matching system 10 to meet changing market demands.

The administrator interface 24 facilitates creating an e-commerce user interface implemented via the website 36. The administrator interface 24 has instructions (including administrator instructions and corresponding implementation software) and input fields for facilitating market type definition. The administrator interface 24 also includes instructions and input fields allowing the administrators 14 to define characteristics associated with entities to be transacted via a market, such as products or services.

The configurator 22 outputs configuration data to an application server 32 residing on the client computer 16. The configurator 22 also communicates with the configuration database 26, which provides input to a matching engine 28. The matching engine 28 provides intelligence input to the configurator 22 and communicates with the transaction database 30 and the application server 32 running on the client computer 16.

The client computer 16 has a web server 34 and a central database 38, which communicate with the application server 32. The web server 34 hosts e-commerce websites 38, which are accessible to the online user community 18 via the Internet 20.

In operation, a company or other organization wishing to use the matching system 10 to generate an e-commerce market provides the market administrators 14 with a clearly defined business model. Such a company is called a net market maker, which is an entity that creates an Internet market to match buyers and sellers. The net market maker does not necessarily own goods.

The administrators 14 input market configuration information to the configurator 22 via the administrator interface 24 in accordance with the selected business model. The market configuration information includes the name and type of market to be configured, which administrators and groups thereof will have access to configure the market, and market behavior information. Market behavior information includes criteria used to match products and/or services to buyers or to match buyers and sellers, the types of transactions used, attributes of goods and/or services to be associated with preferences, importance values (weights) associated with the preferences, whether the preferences will be associated with discrete or continuous attribute variables, and so on, as discussed more fully below.

The configurator 22 allows administrators 14 to set up a market and configure the user interfaces 36 simultaneously. Through a series of drop-down menus and questions, the administrators 14 are guided through the process of setting up the particular market. Administrator input affects operation of the overall matching system 10, including which modules are employed therein, and generates simple user interfaces 36 incorporating user-friendly questionnaires (not shown). The simple and efficient user interfaces 36 make the underlying market generation system 12 and computer 16 transparent to the users.

The configurator 22 is completely customizable so that the administrators 14 can define any number or type of market descriptor variables. The configurator 22 translates this information automatically into a form that is usable by the matching engine 28 and application server 32. The configurator 22 automatically handles complex technical issues associated with generating the e-commerce site 36 and requires only simple input from the administrators 14. The administrators 14 may only be required to complete eight or fewer panels.

Additional details of the administrator interface 24 are discussed more fully in co-pending U.S. patent application Ser. No. [TBA], filed Mar. 30, 2001, by A. Arora, et al., entitled, “Efficient Interface For Configuring An Electronic Market,” (Attorney Docket No. 20512-000130US), assigned to the assignee of the present invention and incorporated by reference herein.

Market configuration information that is input via the administrator interface 24 of the configuration 22 is stored in the configuration database 26. The configuration database 26 also stores configuration information for previously created markets, which enables the administrators 14 to selectively copy configuration information from pre-configured markets to expedite market implementation.

In the present specific embodiment, the configuration information that is provided by the market administrators 14 to the configurator 22 via the administrator interface 24 is sent to the application server 32 on the client computer 16 as an XML (Extensible Mark-up Language) file (config.xml) via HTTP (Hypertext Transfer Protocol) protocol. Use of XML files enhances the portability of the market generation system 12, facilitating interfacing with different client computers running different types of application servers, web servers, and operating systems.

The administrators 14 may selectively activate and deactivate markets. When a configured market is activated, the market configuration information is provided to the application server 32 running on the client computer 16. The matching engine 28 receives configuration information from the configuration database 26. In an active market, configuration information is available to the websites 36 so that buyers and sellers 18 can input data. In an inactive market, market configuration is unavailable to the front end, i.e., websites 36 so that users, such as buyers and sellers, cannot enter data.

The application server 32 runs software for generating and configuring the user interfaces of the websites 36 according to market configuration information (config.xml) received from the configurator 22. The configuration information specifies user interface details, such as what preferences selections for what products or services will be available to the users 18 and how the preferences will be selected by the users 18, such as by drop down lists or text fields.

The application server 32 may perform tasks other than user interface generation and configuration without departing from the scope of the present invention. For example, some matching engine computations may be distributed to the application server 32.

When the users 18 participate in the market, they input their preferences via the website user interfaces 36 by associating importance values with desired attributes associated with entities to be transacted via the current transaction. Their preferences and selections are forwarded to the matching engine 28 via the application server 32. The matching engine 28 performs matching between entities involved in market transactions, such as buyers and sellers, while accounting for buyer and seller wishes or preferences. The matching engine 28 transfers XML files via HTTP to and from the application server 32. The XML files transferred to the matching engine 28 from the application server 32 include have.xml and want.xml, which contain information pertaining to buyer and seller preferences and product and/or service availability. XML files transferred to the application server 32 from the matching engine 28 include buyer.xml and seller.xml, which contain matching information specifying which sellers, buyers, products, and/or services are matched.

The matching engine 28 selectively stores and accesses transaction information on the transaction database 30. The transaction database 30 maintains transaction records, which facilitate market-clearing operations. The administrators 14 may employ the administrator interface 24 to direct the matching engine 28 to clear a market.

The matching engine 28 employs the configuration information to match buyers and sellers, buyers with products or services, or workers with tasks, and so on, according to the configuration information, which may include pre-selected matching techniques. The matching engine 28 receives information pertaining to importance weights assigned to desired attributes by buyers and sellers from the application server 32. The matching engine 28 then searches the transaction database 30 or central database 38 to find and score combinations of buyers and sellers or buyers and products, or workers and job assignments, and so on. The match score computed by the matching engine 28 is based on the importance weights assigned by market participants, such as buyers and sellers. A predetermined number of matches associated with the highest match scores are displayed to the users 18 via the interfaces 36.

For example, a customer searching for a car may specify desired attributes, such as red car, airbag, snow tires, and so on. The customer may assign importance values, such as 0.5, 0.7, and 0.4, respectively, to the desired attributes. This indicates that the customer values airbag safety attributes more than a red paint job and values the red paint job more than snow tires. The match engine 28 then searches a market database, such as the central database 38 that contains information pertaining to cars for sale and their corresponding attributes. The information pertaining to cars for sale may also include information indicating seller preferences. For example, a seller may prefer to sell a car with a high profit margin rather than a car with a low profit margin. The matching engine 28 searches the appropriate database and scores each car based on importance values assigned to the automobile search by the customer and the importance values assigned by the seller. The matching engine 28 then returns match information to the customer, which includes a list of cars that most closely accommodate the customer's preferences (highest match scores) and any seller preferences as indicated by assigned importance weights.

The matching engine 28 of the present invention may accommodate discrete and continuous weights assigned to entities to be transacted. The weights, which are also called importance values, are assigned to attributes (of entities to be transacted) by buyers, sellers, administrators, or other market participants. The matching engine 28 computes a score for a match based on the weights. The exact details of the method for computing the matching score are application-specific and may vary. One skilled in the art with access to the present teachings may easily adapt the methods disclosed herein to accommodate the needs of a given application.

The matching engine 18 may be employed to recommend an optimal market for a given combination of goods and services based on previous transaction information stored in the transaction database 30 and based on intelligence algorithms running on the matching engine 28. These intelligence algorithms may also be employed to perform predictive simulations in accordance with varying parameters as set via the administrator interface 24. Furthermore, these software algorithms may be employed to endogenously define a market based on predetermined criteria. When the market generation system 12 endogenously defines a market, the market is automatically configured to meet the needs of a given market place. The market administrators 14 are then freed from various market design and configuration tasks.

In the preferred embodiment, the matching engine 28 computes a matching score (Zᵢⱼ) according to the following equation:

$${Z}_{ij} = \sqrt{{Z}_{ij}^{i} {Z}_{ij}^{j}} , \qquad [ 1 ]$$

where Zᵢⱼⁱ and Zᵢⱼ^{j} are defined similarly according to the following equation:

$${Z}_{ij}^{i} = \sqrt{{[ {\prod }_{r} ( 1 - {a}_{ir} ( 1 - {D}_{ijr} ) ) ]}^{\frac{1}{R}} [ {\sum }_{r} {δ}_{r} ( 1 - {a}_{ir} ( 1 - {D}_{ijr} ) ) ]} , \qquad [ 2 ]$$

where R is the total number of attributes of index r considered; air is an importance value that the i^{th} seller attaches to the r^{th} attribute. The r^{th} attribute that is associated with the i^{th} seller is associated with an attribute variable xᵢᵣ. When computing Zᵢⱼ^{j} for buyers, aⱼᵣ is an importance value that the j^{th} buyer attaches to the r^{th} attribute. The r^{th} attribute associated with the j^{th} buyer is assigned an attribute variable xⱼᵣ. Dᵢⱼᵣ is a preference variable with a value between zero and one that changes in accordance with how well a seller's desires are satisfied by a buyer's characteristics of vice versa. Dᵢⱼᵣ is given by one of the following equations:

$$\begin{matrix}{D}_{ijr} = max [ 0 , ( 1 - \frac{{C}_{ijr}}{{C}_{r}^{max}} ) ] , or & [ 3 ] \\ {D}_{ijr} = \frac{{ⅇ}^{( 1.946 ( {x}_{ir} - {x}_{jr} ) / {σ}_{r} )}}{1 + {ⅇ}^{( 1.946 ( {x}_{ir} - {x}_{jr} ) / {σ}_{r} )}} , or & [ 4 ] \\ {D}_{ijr} = \{ 0 , 1 \} , & [ 5 ]\end{matrix}$$

where the factor 1.946 may be changed or set by an administrator; σᵣ is the standard deviation of xᵢᵣ-xⱼᵣ; Cᵢⱼᵣ is a non-negative pre-determined value, which may be obtained from a table look-up or other procedure; and Cᵣ^{max} is the maximum tolerable value for Cᵢⱼᵣ, is application-specific, and may be determined by one skilled. Cᵢⱼᵣ may be zero, which is often the best value for Cᵢⱼᵣ. For example if Cᵢⱼᵣ is defined as the distance between two locations, where Cᵣ^{max} is the maximum tolerable distance, all values greater than Cᵣ^{max} would result in Dᵢⱼᵣ=0. With access to the present teachings, one skilled in the art may easily determine values for Cᵢⱼᵣ and Cᵣ^{max} to meet the needs of a given application.

Z_{if} of equation (1) is a weight mapping function that incorporates pre-selected descriptor value evaluation methods via Dᵢⱼᵣ and computes a total match score for market participants i and j, such as sellers and buyers, respectively. If a market does not incorporate seller desires Zᵢⱼⁱ, then equation (1) is not employed and instead, Zᵢⱼ=Zᵢⱼ^{j}.

By scoring matches and allowing users, such as buyers, to assign continuous weights to preferred product attributes, users may specify or rank varying degrees of preferences between attributes. Specifying different preference degrees via importance values or weights enables computation of a total score for a match between entities to be involved in a transaction. The total score reflects the compatibility of the entities involved in the match. Matches with the highest score identify entities that are most compatible to transact with each other. By computing a total score for the match, and selecting the match with the best score, situations wherein no matches are returned are eliminated.

The electronic markets implemented via the customizible matching system 10 of the present invention may employ selectively weighted descriptor variables instead of rigid discrete catagories to describe elements to be transacted such as workers, job asignments, buyers, products, sellers, and so on. However, if certain categorizations are desirable for a certain application, the customizable matching system 10 of the present invention may employ categories in combination with weighted descriptor variables.

In a symmetric exchange market, searched items are scored according to the preferences of both the buyer and seller. Buyer preferences are specified via the user interfaces 36. Seller preferences are often pre-determined by the seller and specified via the administrator interface 24. The match score for a particular transaction incorporates both customer and seller preferences, which are indicated via weights or importance values associated with descriptors only and/or descriptors and descriptor values. A combined score for a particular searched item is computed via one or more predetermined functions, such as a geometric mean or the function of equation (1).

The customizable matching system 10 allows selective ranking of attributes of a given entity to be transacted according to the importance of the attributes to participants in the transaction. This allows markets to score transactions to find and clear the best-matched transactions. Consequently, the customizable matching system 10 of FIG. 1 eliminates primary shortcomings with conventional matching engines and accompanying systems In previous systems buyers were limited to a few product attribute preference selections, such as color, model, and year. Each preference was associated with a discrete value, such as yes or no. The total score for a match between a product and a buyer's preferences was computed as either yes or no. Consequently as the number possible preferences increased, the likelihood of the system returning no matches greatly increased, and accompanying databases became large and impractical. By employing only discrete weights (1 or 0; yes or no) and failing to allow a consumer to rank relative preferences between attributes, conventional matching engines inaccurately modeled the true preferences or desires of the buyers and resulted in systems which were difficult or impractical to implement.

The matching system 10 may include additional modules, such as market/user level personalization modules, pricing modules, and ramp-up modules, without departing from the scope of the present invention. Such modules, and additional details of the matching engine 28, are discussed more fully in an alternative embodiment of the matching system 10 disclosed in co-pending U.S. patent application Ser. No. [TBA], filed Mar. 30, 2001, by A. Arora, et al., entitled “Electronic Matching Engine For Matching Desired Characteristics With Item Attributes,” (Atty. Docket No. 20512-000110US), assigned to the assignee of the present invention and incorporated by reference herein.

The importance weights assigned by buyers to attributes represent either continuous or discrete values and are associated with corresponding continuous or discrete descriptor variables, as predetermined by the market administrator. For the purposes of the present discussion, a discrete variable can take on one of two discrete values or weights, such as 1 or 0, or yes or no. A continuous variable can take on multiple values, called continuous values or weights, over a predetermined range, such as numbers between 0 and 1. A continuous descriptor variable may be assigned a non-discrete weight, such as a number between 1 and 0, to indicate a user-preference level. Continuous descriptor variables are also called analog descriptor variables, and continuous weights are called analog weights.

When an attribute of an item is described by a continuous variable, the present invention may employ a distance method or a more is better method to compute the score of an item. The distance method includes the step of computing the distance between an ideal descriptor value or level associated with a particular product, service, or seller and a true descriptor value or level specified by the buyer. The product, service, or seller associated with the smallest distance is most preferred by the buyer and results in a Dᵢⱼᵣ that is closest to 1 (see equations (1) through (3)).

The distance (D) between two vectors, such as a desired descriptor vector \hat{x}=(x₁, x₂, . . . ,x_{N-1}, X_{N}) and a an actual descriptor vector ŷ=(y₁, y₂, . . . , y_{N-1}, y_{N}) is given by the following equation:

$$D = \sqrt{{( {x}_{1} - {y}_{1} )}^{2} + {( {x}_{1} - {y}_{1} )}^{2} + … + {( {x}_{N - 1} - {y}_{N - 1} )}^{2} + {( {x}_{N} - {y}_{N} )}^{2}} \qquad [ 6 ]$$

The elements of each vector \hat{x} and ŷ represent optimal descriptor weights and actual descriptor weights, respectively, for N corresponding attributes of a particular product or service being searched.

The distance method may employ a tolerance cut-off value. If a score is below the tolerance value, the score is not varied as D varies, but remains constant. The tolerance cut-off value specifies a value beyond which the market administrator does not want to decrease the score in a continuous fashion.

The administrator interface 24 facilities creating an e-commerce user interface and includes software for facilitating market type definition. The software allows the administrator to define characteristics for use in association with an item or service to be transacted.

The customizable matching system 10 may perform predictive simulations in accordance with varying parameters, such as different descriptor variables, evaluation methods, types of descriptor variables (discrete or continuous), and so on. Furthermore, the present invention may recommend an optimal market for a given combination of goods and services. The matching engine 28 incorporates software for identifying a viable market for a given combination of products and services via input received from and buyers and sellers regarding the products and/or services. The combination of products and services is specified by an administrator 14 via the administrator interface 24. The software for recommending an optimal market may employ endogenous or semi-endogenous market selection techniques as discussed more fully below. Possible markets implemented by the customizable matching system 10 include exchange, competitive market, modified competitive market, consignment store, barter, pawnshop, trading post, qualified auction, futures and credit, and internal allocation markets.

Use of the customizable matching system 10 to implementing markets may allow buyers and sellers to rank preferences. For example, a customer shopping for shoes may feel that price is important but shoe size is essential. The present invention enables the customer to specify these different preferences for the price and shoe size attributes by employing importance values, which are assigned to each attribute by the buyer via the interfaces 26. The matching engine 28 of the present invention uses the importance values to compute a match score (Zᵢⱼ) for various products. A controlled number of product matches with the highest match score are returned to the buyer, i.e., customer. The matching engine 28 may compute a total match score that also incorporates seller preferences, such as price, availability, and margin.

In general, the customizable matching system 10 employs various implementation technologies, such as Java, Java Script, Extensible Markup Language (XML), and so on to implement electronic markets. The application server 32 may be implemented by an application server from WebLogic Inc. The customizable matching system 10 is preferably implemented via platform-independent technologies, such as J2EE.

Use of these various technologies improves system scalability and portability. The matching system 10 lacks server affinity so that the user interfaces 36 and application server 32 may be scaled by adding additional servers as needed. Servers may be selectively added and removed from the system 10 to perform load balancing.

In general, the system 10 does not require special proprietary client-side libraries that would reduce system portability. This makes the system 10 compatible with all major browsers, including recent versions of Microsoft® Internet Explorer and Netscape® Navigator. Furthermore, various functional blocks of FIG. 10 are implemented via software modules that employ distributed objects to allow clustering of systems, which facilitates adding new servers without requiring additional programming.

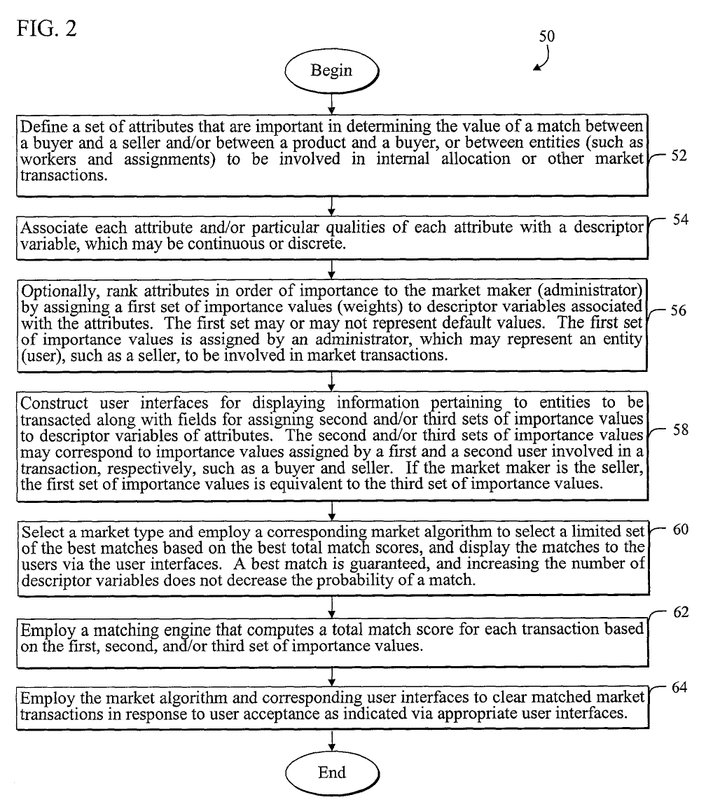

FIG. 2 is flow diagram of a method 50 used by the customizable matching system 10 of FIG. 1 to generate a market in response to input from an administrator. In an initial attribute-defining step 52, an administrator defines a set of attributes and qualities thereof that are important in valuing market transactions. For example, in a used car exchange market, important attributes might be car safety features, color, year, model, make, and so on. Each attribute may be associated with particular qualities, such as red, green, blue, black, and white for the color attribute.

Next, each attribute and/or qualities of each attribute are assigned descriptor variables in a descriptor variable step 54. The descriptor variables may be continuous or discrete. Continuous descriptor variables may be assigned importance values or weights of different values. Discrete descriptor variables are assigned Boolean values representing either true or false, desired or not desired, rejected or not rejected, and so on.

For the purposes of the present discussion, descriptor values and importance values are used interchangeably. However, descriptor values may be considered as variables corresponding to specific qualities of an attribute, to which importance values are assigned. For example, a descriptor variable describing product material may be associated with a descriptor value representing nylon or leather. The descriptor value may be assigned an importance weight or value by an administrator or other market participant as discussed more fully below.

Subsequently, in an optional ranking step 56, the administrator employs the administrator interface 24 of FIG. 1 to rank attributes in order of importance to the administrator. The attributes are ranked by assigning a first set of importance values to the different attributes. If the administrator represents a seller, the first set of importance values accommodates seller preferences. For example, a seller may assign a high importance value to a ‘high price’ descriptor value associated with a descriptor variable that describes price. Alternatively, the first set of importance values may represent default values set by the administrator, who may represent a seller. The optional ranking step 56 may be omitted without departing from the scope of the present invention.

With reference to FIGS. 1 and 2, in a subsequent interface-generating step 58, the application server 32 running on the client computer 16 constructs a user interface(s) according to a configuration file transferred from the configurator 22. The user interfaces include various fields, such as drop down menus and/or text boxes, which allow market participants to selectively assign importance values to entities to be transacted. If the market participants include a buyer and a seller, buyer and seller importance values are assigned to a given product or service to be transacted, which represent second and third sets of importance values, respectively. Alternatively, the seller importance values may indicate which buyers the seller wishes to do business with based on buyer qualities. The buyer importance values may indicate which sellers the buyer wishes to transact with based on seller qualities.

Alternatively, if no intermediate product is involved, such as in an internal allocation application that matches workers to job assignments, then the second set of importance values represents values assigned by workers to attributes of the task to be performed. The third set of importance values represents values assigned by the company or employer. In the present internal allocation example, the third set of importance values may be associated with attributes of the workers. The second set of importance values may be associated with attributes of the job assignments.

Next, in a matching step 60, the matching engine 28 computes a total match score for each transaction based on the first, second, and/or third set of importance values. To compute a match score, the matching engine 28 may employ one of several descriptor variable evaluation methods applicable to a given descriptor variable. The exact evaluation method selected for a given descriptor variable is application specific and may be determined by one skilled in the art will access to he present teachings.

Descriptor evaluation methods include the following methods: equal to, not equal to, strictly less than, strictly more than, less than or equal to, more than or equal to, distance, more is better (only available for continuous descriptors), and less is better (only available for continuous descriptors) methods. The various evaluation methods map preference selections and importance value assignments into a predetermined number range, such as between 0 and 1, with a higher value representing a more preferred selection.

For example, a market administrator representing an online shoe store may configure the user interfaces 36 to include material and traction descriptor variables, which describe the material composition of the shoe and traction qualities, respectively. The descriptor variables may be associated with drop down menus that allow users to select qualities for the different descriptor variables, where the qualities correspond to descriptor values. For example, the material descriptor variable may include drop down options corresponding to descriptor values such as leather, nylon, or canvas. The traction descriptor variable may include drop down options corresponding to descriptor values such as low traction, medium traction, and high traction.

If the administrator chooses to make the material and traction descriptor variables continuous descriptor variables, then users are given an option to assign importance values or weights to the corresponding descriptor values of leather, nylon, canvas, low traction, medium traction, and high traction. The importance values are assigned to descriptor values on a scale of A to B, where A is the least important, and B is the most important to the user. If a user assigns and importance value of X, then A≦X≦B. If the administrator has chosen the distance method for evaluating descriptor variables, then Cᵢⱼᵣ is computed based on the distance or difference from the desired attribute level B and the actual attribute level X. This relation is then used to calculate Dᵢⱼᵣ in accordance with equation (4) and weighted by importance value between A and B, which is generally transformed into a number between zero and one.

If the evaluation method is selected as the equal to method, then the importance value assigned to a descriptor value by a user is evaluated as being equal to the desired attribute level or not. Descriptor variables evaluated according to the equal to method are discrete variables. For example, if the shoe material attribute is set as a discrete variable by a market administrator, and a user selects the leather descriptor value, then Dᵢⱼᵣ evaluates to 1 if the material of a shoe is leather and 0 if not, where Dᵢⱼᵣ takes on values between 0 and 1 ranging from worst match to best match. Of course, there is no requirement that D take on a value of zero or one, this is merely a special case of the continuous form of D which varies from zero to one continuously.

The evaluation methods compare buyer and seller descriptor values and check for the corresponding conditions. For example, if the evaluation method for a continuous descriptor is the distance method, then the match score for the descriptor decreases linearly based on the distance (difference in values) between the desired attribute level from the buyer's perspective and the attribute level associated with a particular product, such as a shoe. For discrete variables, an equal to evaluation option is employed and selected via the user interfaces 36 or the administrator interface 24 of FIG. 1.

The operations of the other evaluation methods, such as greater than or equal to, less than or equal to, strictly less than, and strictly more than are evaluated in accordance with their names like the distance and equal to methods. Those skilled in the art with access to the present teachings may easily implement the remaining methods without undue experimentation.

Hence, the matching engine 28 computes match scores for market transactions based on the predetermined descriptor variable evaluation method (such as the more is better method, the equal to method, the less is better method, and the distance method) specified via the administrator interface 24 and based on a match score computation method. The match score computation method is detailed in equations (1) through (5). The predetermined evaluation method maps descriptor values into corresponding preference numbers (Dᵢⱼᵣ) within a predetermined number range, such as between 0 and 1. The evaluation methods are pre-selected by an administrator via the administrator interface 24 of FIG. 1 by selecting corresponding descriptor evaluation options. The actual evaluation methods are implemented via software of the matching engine 28. Alternatively, evaluation methods may be selected via the user interfaces 36 of FIG. 1 without departing from the scope of the present invention.

With reference to FIG. 1 and the method 50 of FIG. 2, after the matching step 60, control is passed to a market identification step 62. In the market identification step 62, a market administrator selects a market type, or a market is selected endogenously, i.e., automatically by the market generation system 12.

Market participants (users) or the administrators 14 of FIG. 1 may define the number of matches to displayed for a given search or matching operation. Using match scores guarantees that one or more best matches will be returned in response to a search or matching operation. Furthermore, unlike with conventional categorical markets, the probability of successfully recommending a product based on customer preferences and associated match scores of a particular search does not decrease as the number of descriptor variables or specified categories increase. Consequently, the present invention enables implementation of certain market types that would otherwise be impossible to electronically implement via conventional categorical matching engines.

The market generation system 12 can perform market simulations based on configuration information provided to the configurator by the administrators 14 to recommend and/or select an appropriate market. The simulations are implemented via simulation software and associated intelligence algorithms running on the matching engine 28. The simulation software may be constructed by one skilled in the art with access to the present teachings.

The simulation software of the matching engine 28 may incorporate an endogenous market definer (implemented in software of the matching engine 28) that automatically defines attribute descriptor variables based on pre-existing market data. The semi-endogenous market definer selects a starting participant, such as a seller, to participate in market transactions. The starting seller is chosen to match best with all buyers participating in the electronic market.

To match best with all buyers, the starting seller must maximize ΣⱼZᵢⱼ, where i is a seller index, j is a buyer index, and Zᵢⱼ is a total match score for the i^{th} seller and the j^{th} buyer (See equations (1) through (5)). Additional sellers are selected to participate in the electronic market if they satisfy following conditions:

$${\sum }_{j} \frac{( {z}_{kj} - {\overline{z}}_{k} ) ( {z}_{ij} - {\overline{z}}_{i} )}{{σ}_{kj} {σ}_{ij}} > {T}_{1} , \\ {\sum }_{j} {Z}_{ij} > {T}_{2} , \qquad [ 7 ]$$

where k represents the value of the seller index i associated with the starting seller; zᵢⱼ is a match value of a match between a seller i (an i^{th} seller) and a j^{th} buyer; z^{kj} is a match value of a match between the starting seller k and a j^{th} buyer; \overline{z}ₖ is an average of all match values of the matches between the starting seller k and all buyers j; \overline{z}ₖ is an average of all match values of the matches between the seller i and all buyers j; σₖⱼ is a standard deviation of zₖⱼ taken across all buyers j; σᵢⱼ is a standard deviation of zᵢⱼ taken across all buyers j; T₁ is a first predetermined threshold; and T₂ is a second predetermined threshold. T₁ is application-specific may be determined by one skilled in the art without undue experimentation.

Types of Markets

The market algorithm selected in the market identification step 62 may be an internal allocation market algorithm, a business-to-business concierge market algorithm, a modified competitive market algorithm, an electronic pawn shop market algorithm, an electronic wholesaler market algorithm, a trading post market algorithm, an auction or qualified auction market algorithm, a web credit market algorithm, etc. Many types of markets can be advantageously run with the advantages provided by the matching engine of the present invention. The market algorithms facilitate implementation of corresponding markets types of the same names as discussed more fully below.

The customizable matching system 10 of FIG. 1 and the method of present invention may be employed to implement various types of markets and to form new and advantageous markets that could not previously be implemented. For example, modified competitive markets represent a new type of market enabled via the present invention.

A competitive market assumes that all goods are homogeneous, having similar attributes. The modified competitive market and corresponding method or algorithm clears in two steps. First, goods or services within the market are assumed to be homogeneous, and market equilibrium price is computed as it is in standard competitive markets by matching buyers and sellers and supply and demand. However, in standard competitive markets, buyers and sellers are assumed to be identical, and consequently, pairing of a buyer with a seller is arbitrary. All matches are assumed equivalent to each other. For example, in the market for shares of GM stock, assignment of shares to particular qualified buyers is arbitrary since the buyers are considered equivalent. However, in a modified competitive market, the matching is not arbitrary. After the equilibrium market price for a transaction is computed, buyers are matched with sellers according to match scores. For example, sellers of carpentry services might be paired with buyers according to location and other factors that make a given seller a better match with a given buyer. If a modified competitive market is selected for implementation via the configurator 22 and administrator interface 24 of FIG. 1, then modified competitive market software running on the matching engine 28 pairs participants in transactions, such as buyers and sellers, in accordance with a match score. The match score is based on descriptor variables, corresponding descriptor values, and assigned importance values pertaining to qualities associated with the market participants.

In a symmetric exchange market implemented by the present invention, preferences of both participants in a market transaction (both buyer and seller preferences) are accommodated. When a buyer searches for items, the searched items are scored in accordance with the preferences of the buyer and seller. Buyer preferences are specified via the user interfaces 36. Seller preferences may be pre-determined by the seller and specified via the administrator interface 24. The score for a particular item incorporates both buyer and seller preferences, which are indicated via importance values. A combined score for a particular searched item is then computed via a predetermined function, such as a geometric mean or via equation [1].

Examples of markets that can be run with the system of the present invention include the following:

Competitive Markets

Competitive markets can be run when there are many units of a homogeneous good or service for sale and many potential purchasers. Under such circumstances, there is typically one market clearing price. All buyers who are willing to pay at least that price get the good or service and all sellers who are willing to provide the good or service for less than the clearing price are guaranteed a sale. The engine runs competitive markets for any good or service.

Additionally, the engine actually has a method for determining how best to set up a market. Consider, for example, a competitive market for the purchase of puppies. Many types of puppies exist. For example, the market can be a market for one or more of the following: dogs, large dogs, Labrador Retrievers, Yellow Labrador Retrievers, Female Yellow Labrador Retrievers, or Female Yellow Labrador Retrievers under 3 months of age who live in the San Francisco Bay Area, etc. Alternatively, there may not be enough Yellow Labradors in an existing market (e.g., for dogs) or in a particular geographic or demographic segment of sellers to create an efficient market. The narrower the category, the better is the match, but the narrower the category, the less likely there are to be a significant number of buyers and sellers within a category. By examining desired trading patterns, the engine can automatically suggest or design the best market.

Modified Competitive Markets

In a competitive market, all goods or services transacted are assumed to be identical. After the market clears, the assignment of buyer to seller is arbitrary. In a Modified Competitive Market, assignment of buyer to seller is made on the basis of other, secondary, characteristics after the market clears. In the puppy example, a buyer might be assigned to a seller on the basis of size or on the distance between buyer and seller. The engine runs modified competitive markets that run like a competitive market, but assigns buyers to sellers on the basis of secondary characteristics.

The Consignment Store

Currently, most web-based trades are either company-specific, where a buyer goes directly to the web site of a particular firm, or they occur on exchanges that are run as auctions. One alternative is to create a generalized consignment store, where goods and services are priced and buyers are matched to them, based on a potentially large set of criteria. Auctions, where prices are not specified in advance, have some advantages to sellers, but many disadvantages to buyers, who would like to be certain that a bid results in a purchase. Imagine buying groceries by auction. Bidders at 9:00 am would have to wait until noon to know whether they obtained the breakfast cereal that they bid on. Stores, where goods are available at a specified price, are much more efficient than auctions for such goods.

In consignment stores, sellers list their goods or services at a specified price. Buyers list the attributes of the good or service that they want to purchase and are linked with any number of potential sellers. The exchange receives a commission when a match or actual trade occurs.

The engine creates consignment stores and allows the store to price the transaction, collect revenue on the basis of trades or matches provided or on a subscription basis.

The B2B Concierge

There are four models for current B2B transactions. The newest is the buying consortium. Others include auctions, catalog exchanges, and single store sales. For a variety of reasons, there are many situations when none of these is the most efficient.

An alternative, based on the consignment store model simply arranges the best matches between buyers and sellers. Here, sellers list their products and buyers list the characteristics of the input that they want.

A seller's price listing is a commitment to sell at that price, so the buyer is assured of supply once the ask price is offered. This differs from a catalog in that buyers are matched to sellers on the basis of attributes, not a hierarchical or index style rigid matching. It differs from other stores in that many suppliers and many buyers are handled in the market simultaneously.

Barter

Barter exchange is idiosyncratic. Every individual or firm in the barter market is both a buyer and a seller. One firm is willing to trade something in return for something else. Another firm must be found that will accept the item offered and offer the item that is desired in return. Furthermore, this must be done at appropriate “prices” or ratios of one good to another. (For example, how many computers does one firm provide in return for one hour of consulting time provided by the other firm?)

Since the system of the present invention can handle any number or type of attributes, it is ideally suited for creating barter matches. The engine has the capability of running barter markets of all types, and it can provide implicit prices to the traders in the market. Furthermore, it can charge users on the basis of matches, actual trades, or on a subscription fee basis.

Electronic Pawnshops

A pawnshop differs from a consignment store in that the pawnshop buys the good or service from the seller before there is an actually buyer for the good or service. The owner of the pawnshop bears the risk. After committing to buy the good or service, the owner loses money if no sale or a a sale at a low price occurs and makes money if a sale occurs at a price above the purchase price. Unlike the consignment store, there is no commission; the pawnshop earns on the basis of the sell-buy spread.

The inventory may be a virtual one. There is no need for the pawnshop actually to hold the goods that it purchases. But it is necessary that delivery be guaranteed before payment is made.

The engine runs electronic pawnshops, keeping track of promised purchased price and actual transactions.

Electronic Wholesaler

Wholesalers who transact between businesses in the non-electronic world hold real inventories of real supplies. They bear the risk in that they own the intermediate goods that they sell. Similarly, the electronic wholesaler owns a variety of supplies from many different basic material suppliers and sells to firms that want to purchase inputs. If the price spread between purchase price and sales price is high, the wholesaler makes a large profit. If not, the wholesaler may take losses. Risk is borne by the wholesaler, not by the seller.

As such, the electronic wholesaler is a B2B version of the pawnshop, where the wholesaler owns the inventory (although it need not be in the physical possession of the wholesaler.) As with the B2B concierge, buyers specify the attributes of the supply they want and are matched with the relevant supplier. The difference between this market structure and the B2B concierge is that the wholesaler actually owns the supplies; the concierge merely acts as a matchmaker.

Trading Posts

A trading post is the barter-equivalent of an electronic pawnshop. In an electronic trading post, firms or individuals offer goods or services in return for other goods or services. In the pawnshop, individuals offer goods and services in return for money. Purchasers use money as the currency of the pawnshop. Purchasers use goods and services as currency at the trading post.

Trading posts have many of the attributes of barter, but have one major advantage. It is unnecessary to have a “double coincidence of wants” to complete a trade. In barter, if one trader wants to trade computers for computer consulting services, there must be another trader who wants to trade computer consulting services for computers. In a trading post, one trader gives up computers and receives computing services, but the supplier of the computer services is not necessarily (and usually is not) the trader who receives the computers. Computer services and computers are held in virtually inventory and are made available when someone or some finn wants to trade something for them.

Trading posts are like electronic pawnshops in that the owner of the post bears the risk.

Just as the engine supports barter and electronic pawnshops, so too can it run an electronic trading post, keeping track of relative prices of one good or service in tenns of another good or service.

Auctions

Auctions are already well-established on the internet. The engine runs all the standard auctions including English, Dutch, Japanese, sealed bid, and allows different pricing rules such as first-price and second-price aucitons. It also permits the administrator to set auction rules including minimum prices, minimum bid increments, and maximum time between bids.

The engine accommodates seller-bid auctions as well as buyer-bid auctions. An example of a seller-bid auction is one where a buyer wants something done and is willing to accept bids for the job. RFPs of all sorts, including construction, research, and consulting fit this category.

Qualified Auctions

A qualified auction is an auction where only certain individuals or firms are deemed qualified to bid. Because the engine understands desired trading patterns, it can qualify buyers and/or sellers before an auction is run.

Consider, for example, a firm that wants to have a warehouse built. There are many potential bidders, but some are “nuisance” bidders in that the firm would never accept their services, no matter what their bid. The engine can qualify bidders on the basis of how well the characteristics of the bidder match those desired by the buyer.

Similarly, there are situations in which a seller of a good might want to reject some bidders because the seller is concerned that the bidders' offers are disingenuous. Auctions of houses might fall into this category, where the seller of a house cares about buyer characteristics because the seller wants to be certain that a bid will translate into an actual sale. The engine can qualify bidders on the basis of their match characteristics as specified by the seller or administrator.

Credit

The engine can operate a market where time of payment is different from time of receipt, thereby creating a credit operation.

Consider, for example, the electronic consignment store application. A buyer might want to take delivery of a good six months from now, but pay for it one year from now. A seller might want payment today, even though delivery does not occur for another six months and payment from the buyer is not received for another year. The engine allows the store to price the good, and then after entering an interest rate, calculates the amount that the seller receives today and that the buyer pays one year from now. It keeps track of the transaction and infonns the administrator when payment must be made and when payment is due.

Technically, it is not necessary that any good exchange hands at all. As such, the engine has the ability to operate a credit market, pairing lenders and borrowers on the basis of their characteristics.

Internal Allocation

Because the engine has the ability to match and price any transaction, it can be used as an internal allocation engine, sorting workers with tasks, projects to departments, or workers to managers, among other applications.

Consider, for example, a firm that has one hundred account executives and one hundred different clients. The task is to assign one executive to each account, but to do so in a way that matches the characteristics of the executives with those needed in each account. Furthermore, once an executive is assigned to one account, he or she cannot be assigned again to another account. The engine performs this assignment, and does so according to any of a number of administrator-chosen criteria. These include maximizing the average quality of the match and maximizing the quality of the best match.

Auction Type Generation

The present invention provides a tool for helping to create an auction type of electronic marketplace. In Table I, several characteristics of auctions are listed in the top row such as “Supply (Demand) Structure,” “Number of Goods,” “Bidding Structure,” etc. An administrator can create an auction by choosing one characteristic value from under each heading's column. Not all columns need to be used. Not all combinations are feasible.

In an alternative embodiment of the present invention, an administrator can simply indicate which values are desirable and the auction is automatically created in accordance with the selections.

TABLE I

| | Number | Bidding | Stopping | Bidding | Winning | | |
|---|---|---|---|---|---|---|---|
| Supply (Demand) Structure | of goods | Structure | Rule | increment rule | Rule | Pricing Rule | Information Options |
| Perfectly inelastic (accept any | one | One time bid | Time either | % of last bid | Highest | Action (own | Bidding history (and |
| price) (one or many identical | | | completion | | bid | bid | timing) public |
| goods auctioned at once) | | | or run time) | | (Lowest bid) | | |
| Perfectly inelastic above | many as | Sequential | Reach | function of | Highest n | Lowest | Bidding history |
| (below) some min. price | package | bottom up (top | target | time since last | bids | winning bid | secret; only current |
| (Accept any winning bid | | down) with | number of | bid | | (In reverse | highest bid |
| above (below) minimum | | permitted re- | bids — stop | | | auction, | announced. |
| (maximum) price) (One or | | entry of drop- | after the n^{th} | | | highest | |
| many goods auctioned at | | out bidders | bid | | | winning ask) | |
| once) | | | | | | | |
| Upward sloping supply: | many but | Simultaneous | Time | function of last | First bid | Highest losing | Bidder's identity and |
| (Downward sloping demand) | bid on | bidding bottom | interval | bid and of time | | bid (In reverse | bidding history |
| Multiple goods with some | full set or | up (top down) | after | since last bid | | auction, lowest | public |
| goods reservation price lower | subset | without | preceding | | | losing ask) | |
| than other goods reservation | (this can | permitted re- | bid has | | | | No information |
| price even though goods are | be diff. | entry of drop- | passed | | | | made public. Each |
| identical. | goods or | out bidders — | without | | | | bidder told whether |
| | some | Once out, | another bid | | | | he won or lost. |
| | number | always out, | | | | | |
| | of same | Everyone bids | | | | | |
| | good) | every round or | | | | | |
| | | out. | | | | | |
| | many sold | One time bid | Bid (or ask) | Fixed amount | First n | | Highest bidder's |
| | or bought | on both price | hits some | | bids | | identity public or not |
| | in subsets | and quantity | level | | | | |
| | | | Only n | % of last bid | Last n | | Winning bidder's |
| | | | bidders left | | remaining | | identity public or not |
| | | | | | bidders | | |
| | | | | Bidder chosen | One price beats | | (The above |
| | | | | | another by | | selections are not |
| | | | | | some margin | | mutually exclusive) |
| | | | | Fixed or | | | Winning bid public |
| | | | | functional | | | |
| | | | | increment per | | | |
| | | | | unit of time | | | |

For example, an auction where the number of goods is one, one time bids are allowed, the auction stops at a specific time and the bidding increment is a function of time since the last bid can be created by selecting the appropriate four values from the chart in Table I. Not only does this approach provide a systematic way to specify auctions, but administrators can be led into auction types that are appropriate for a specific application. In an embodiment, for example, the chart can be displayed on a display screen while the administrator/user clicks on chart values. After each value is selected, values which are not permissible can be removed from possible selection (e.g., by shading out their text) and values which are newly possible can be provided for selection (e.g., by displaying the new values in appropriate positions in the chart.

Market Clearing

With reference to the method 50 of FIG. 2, control is passed to a market-clearing step 64 after the market selection step 62. In the market-clearing step, a market-clearing algorithm corresponding to the type of market selected via the administrators 14 and the interface 24 of FIG. 1 or selected automatically by the matching engine 28 and configurator 22, clears the market. The selected market and corresponding market-clearing software (algorithm) employs input from the user interfaces 36 to clear matched transactions. Depending on the type of market selected, market participants may have the option to accept or decline a matched transaction via the interfaces 36.

In a specific implementation, buyers and sellers participate in transactions, and one-to-many market-clearing software and/or one-to-one market-clearing software is used by the matching engine 28 and corresponding market-clearing software to clear markets. The one-to-one market-clearing software includes routines for searching all total match scores Zᵢⱼ for seller i and buyer j. The one-to-one market-clearing software then selects the maximum value of Zᵢⱼ and then participant i is assigned to participants to yield cleared participants in response thereto. The one-to-one market-clearing software then removes Zᵢⱼ corresponding to the cleared participants from the set of all Zᵢⱼ to yield a reduced Zᵢⱼ. The one-to-one market-clearing software then repeats the above steps for the reduced Zᵢⱼ. The one-to-one market-clearing software also includes routines for clearing markets by maximizing the sum of all matches Zᵢⱼ for the total market and clearing sections of a matrix of values corresponding to Zᵢⱼ.

Those skilled in the art will appreciate that the order of the steps of the method of FIG. 2 may be permutated to meet the needs of a given application without departing from the scope of the present invention.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

What is claimed is:

1. A system for implementing an electronic market comprising:
first means for defining a set of attributes and associated descriptor variables involved in market transactions and assigning importance values to said descriptor variables;
second means for computing match scores for said market transactions based on quality of the match for each of the attributes and importance values associated with each of the attributes; and
third means for clearing said electronic market in accordance with said match scores.

2. The system of claim 1 wherein said first means includes an administrator interface for allowing an administrator to define said descriptor variables.

3. The system of claim 2 wherein said first means includes a configurator in communication with said administrator interface for allowing said administrator to assign a first set of one or more importance values to one or more of said descriptor variables, respectively.

4. The system of claim 3 wherein said first set of one or more importance values includes default importance values.

5. The system of claim 4 wherein said first set of one or more importance values includes seller importance values assigned to said descriptor variables by a seller seeking to transact with a buyer via said electronic market.

6. The system of claim 3 wherein said administrator interface includes means for configuring a user interface of said market to allow a participant in a market transaction to assign a second set of one or more of said importance values to said descriptor variables.

7. The system of claim 6 wherein said second set of one or more importance values includes buyer importance values assigned to said descriptor variables by a buyer seeking to transact with a seller via said electronic market.

8. The system of claim 7 wherein one or more of said descriptor variables are continuous descriptor variables.

9. The system of claim 1 wherein said second means includes a matching engine for computing said match scores based on a predetermined evaluation method specified via said administrator interface and a match score computation method.

10. The system of claim 9 wherein said predetermined evaluation method includes means for mapping descriptor values into corresponding preference numbers (Dᵢⱼᵣ) within a predetermined number range.

11. The system of claim 10 wherein said predetermined evaluation method includes a more is better method, an equal to method, a less is better method, a distance method and qualitative evaluations methods.

12. The system of claim 10 wherein said predetermined number range is between 0 and 1.

13. The system of claim 12 wherein said matching engine includes software for computing a total match score (Zᵢⱼ) according to said match score computation method based on said importance values according to the following equation:
$${Z}_{ij} = \sqrt{{Z}_{ij}^{i} {Z}_{ij}^{j}} ,$$
where Zᵢⱼⁱ is a match score based on importance values assigned by a first participant in said electronic market and any corresponding preference numbers Dᵢⱼᵣ, and Zᵢⱼ^{j} is a match score based on importance values associated with a second participant in said market and any corresponding preference numbers Dᵢⱼᵣ

14. The system of claim 13 wherein said first participant is a seller and said second participant is a buyer.

15. The system of claim 12 wherein said third means includes one-to-many market-clearing software.

16. The system of claim 12 wherein said one-to-many market-clearing software.

17. The system of claim 12 wherein said third means includes one-to-one market-clearing software.

18. The system of claim 17 wherein said one-to-one market-clearing software includes means for searching all total match scores Zᵢⱼ for market participants i and j; selecting the maximum value of Zᵢⱼ; matching participant i to participant j to yield cleared participants in response thereto; removing Zᵢⱼ corresponding to said cleared participants from the set of all Zᵢⱼ to yield a reduced Zᵢⱼ; and repeating the above steps for the reduced Zᵢⱼ.

19. The system of claim 18 wherein said means for clearing markets includes means for selectively clearing sections of a matrix of values corresponding to Zᵢⱼ.

20. The system of claim 1 wherein said third means includes an endogenous market definer for automatically defining said descriptor variables based on pre-existing market data.

21. The system of claim 1 wherein said third means includes a semi-endogenous market definer.

22. The system of claim 21 wherein said semi-endogenous market definer includes means for selecting a starting seller to participate in market transactions, said starting seller best matched with all buyers participating in said electronic market.

23. The system of claim 22 wherein said means for selecting includes means for selecting, as said starting seller, a seller that maximizes ΣⱼZᵢⱼ, where i is a seller index, j is a buyer index, and Zᵢⱼ is a total match score for the i^{th} seller and the j^{th} buyer.

24. The system of claim 23 wherein said semi-endogenous market definer includes means for selecting additional sellers to participate in said electronic market, said additional sellers satisfying the following conditions:
$${\sum }_{j} \frac{( {z}_{kj} - {\overline{z}}_{k} ) ( {z}_{ij} - {\overline{z}}_{i} )}{{σ}_{kj} {σ}_{ij}} > {T}_{1} , \\ {\sum }_{j} {Z}_{ij} > {T}_{2} ,$$
where k represents the value of the seller index i associated with said starting seller; zᵢⱼ is a match value of a match between a seller i (an i^{th} seller) and a j^{th} b buyer; zₖⱼ is a match value of a match between said starting seller k and a j^{th} buyer; \overline{z}ₖ is an average of all match values of the matches between said starting seller k and each seller j; \overline{z}ᵢ is an average of all match values of the matches between said seller i and each seller j; σₖⱼ is a standard deviation of zₖⱼ taken across all buyers j; σᵢⱼ is a standard deviation of zᵢⱼ taken across all buyers j; T₁ is a first predetermined threshold; and T₂ is a second predetermined threshold T₂≈ΣⱼZᵢⱼ.

25. The system of claim 1 wherein said electronic market is an internal allocation market, a business-to-business concierge market, an electronic pawn shop market, an internal allocation market, electronic wholesaler, a trading post, an auction, or a web credit market.

26. The system of claim 25 wherein said auction is a qualified auction wherein market participants are qualified based on said match scores.

27. The system of claim 1 wherein said electronic market is a modified competitive market and said third means includes modified competitive market-clearing software.

28. The system of claim 27 wherein said modified competitive market-clearing software includes means for pairing buyers and sellers in accordance with a match score incorporating descriptor variables pertaining to qualities of said buyers and sellers.

29. A system for generating an e-commerce website comprising:
first means for indicating products and/or services to be sold via said e-commerce website;
second means for providing a list of attributes associated with said products and/or services;
third means for selectively associating weights with said attributes; and
fourth means for automatically generating an e-commerce website in accordance with said products and/or services, said list of attributes, and said weights.

30. The system of claim 29 wherein said third means includes a user interface and an administrator interface in communication with a weight-mapping function.

31. The system of claim 29 wherein said fourth means includes means for selecting a type of market for use with said e-commerce site.

32. The system of claim 31 wherein said type of market is an exchange model, a competitive market, a modified competitive market, a consignment store, a qualified auction, an internal allocation, and/or a futures and credit market.

33. The system of claim 29 wherein said fourth means includes means for searching a market database in accordance with said attributes and weights of said products and/or services.

34. The system of claim 33 wherein said means for searching a market database includes fifth means for receiving one or more inputs; sixth means for selectively weighting said one or more inputs and providing one or more weighted inputs in response thereto; and seventh means for accessing data in said database in accordance with said one or more weighted inputs.

35. The system of claim 34 wherein said means for searching a market database is an e-commerce search engine for matching products or services to a user of said engine in accordance with said one or more inputs input by said user and/or said administrator.

36. The system of claim 35 wherein said sixth means includes one or more interfaces for specifying a continuous or discrete weight.

37. The system of claim 36 wherein said one or more interfaces includes a user interface and an administrator interface, said administrator interface includes means for allowing said administrator to adjust default weights associated with said products and/or services.

38. A matching system comprising:
first means for receiving one or more inputs;
second means for selectively weighting said one or more inputs via a continuous weight and providing one or more weighted inputs in response thereto; and
third means for accessing data in accordance with said one or more weighted inputs.

39. The system of claim 38 wherein said first means includes a user interface and an administrator interface, said administrator interface including means for allowing said administrator to adjust default weights associated with said products and/or services.

40. A matching system for implementing a transaction in accordance with preferences or match criteria comprising:
first means for receiving preferences or match criteria as input;
second means for ranking said preferences or match criteria according to importance and providing ranked criteria in response thereto; and
third means for accessing data in accordance with said ranked criteria.

41. An electronic market for implementing a transaction between a first entity and a second entity system:
first means for individually valuing relative preferences of characteristics associated with said second entity relative to said first entity and providing preference values in response thereto and
second means for searching a database having information pertaining to plural second entities and returning a matched result pairing said first entity with said second entity selected from said plural second entities based on said preference values; and
third means for clearing said electronic market according to said matched result.

42. The system of claim 41 wherein said first entity corresponds to one or more users, said second entity corresponds to one or more products or services, and said characteristics are attributes associated with said one or more products or services.

43. The system of claim 41 wherein said first means includes a user interface for inputting said relative preferences in terms of continuous or discrete values associated with each of said attributes.

44. An e-commerce market comprising:
first means for ranking preferences of attributes associated with a product or service based on user input and providing ranked preferences in response thereto;
second means for searching a database of said products or services and returning one or more matched results based on said ranked preferences; and
third means for clearing said market according to said matched results.

45. The system of claim 44 wherein said one or more users include a buyer and a seller.

46. The system of claim 45 wherein said first means includes means for enabling a user to describe each of said attributes.

47. The system of claim 46 wherein said means for enabling further includes means for permitting said customer to assign a first set of values to said attributes.

48. The system of claim 47 wherein said means for enabling further includes means for permitting a seller to assign second set of values to said attributes.

49. The system of claim 48 wherein said second set of values represent default values.

50. The system of claim 49 wherein said system further includes a means for scoring each product or service in accordance with said first set of values and said second set of values associated with said attributes of said product or service.

51. An electronic market comprising:
first means for receiving one or more inputs;
second means for selectively weighting said one or more inputs via a continuous weight and providing one or more weighted inputs in response thereto; and
third means for accessing data in accordance with a match score computed by a mapping function, said match score representative of the quality of a match between said data and said one or more weighted inputs; and
fourth means for clearing said electronic market in accordance with said match score and data.

52. The system of claim 51 wherein said second means includes one or more interfaces for changing said continuous weight to a discrete weight.

53. The system of claim 52 wherein said one or more interfaces includes a user interface and an administrator interface, said administrator interface including means for allowing said administrator to adjust weights associated with said data, said data associated with products and/or services.

54. A system for matching user preferences with a product or service comprising:
user interface for specifying relative preferences of attributes associated with said product or service by ranking said preferences via input from one or more users and
means for searching a database of said products or services and returning one or more matched results based on said relative preferences.

55. The system of claim 54 wherein said efficient matching engine includes means for searching a database of said products and/or services and returning one or more matched results based on said relative preferences and said first set of preferences.

56. The system of claim 55 wherein said one or more users include a buyer and a seller.

57. The system of claim 56 wherein said user interface includes means for allowing a buyer to assign a second set of values to said attributes and includes means for permitting a seller to assign a third set of values to said attributes, said second set of values representing default values, which are associated with said attributes when said first set of values are not provided by said buyer.

58. The system of claim 57 wherein said system further includes a means for scoring each product or service in accordance with said first set of values, said second set of values, and said third set of values associated with said attributes of said product and/or service.

59. A method for implementing an electronic market comprising the steps of:
defining a set of attributes and associated descriptor variables involved in market transactions and assigning importance values to said descriptor variables;
computing match scores for said market transactions based on said importance values; and
clearing said electronic market in accordance with said match scores.
